(19) United States
(12) Patent Application Publication
(10) Pub. No.: US 2007/0299753 A1
(43) Pub. Date: Dec. 27, 2007

(54) Participatory equity appreciation contract ("PEAC")

(76) Inventors: Michael Averbuch, Quincy, MA (US); Pieter Weyts, New York, NY (US)

Correspondence Address: Pedro C. Fernandez;Cooper & Dunham LLP, 1185 Avenue of the Americas, New York, NY, 10036, US

(21) Appl. No.: 10/742,336

(22) Filed: Dec. 19, 2003

(51) Int. Cl. G06Q 40/00

(52) U.S. Cl. 705/35

(57) ABSTRACT

A system and method for managing the risk for prospective real estate property buyers of price volatility in the real estate market in which they intend to purchase a property, without the need to make an immediate purchase. Data is input into a computer system and the computer system is used to prepare a Participatory Equity Appreciation Contract or “PEAC” which grants the prospective property owner, in exchange for a fee, the right to receive a payout, calculated as a function of the deviation of the real estate index of the geographic area in which the prospective purchaser intends to purchase a property, upon the earlier of: (i) the end of the term of the contract, or (ii) the occurrence of a life event such as the time the prospective purchaser actually purchases a property in the area. The prospective property owner can only receive the payout upon occurrence of a life event such as the time of purchase of a property in such area, which may be later than the end of the term of the PEAC. The payout is a payment composed of one or more tier payments, each corresponding to a particular range of index increments. For each range of index increments, the respective tier payment consists of a certain pre-determined amount or a share of a certain pre-determined amount.

### FIELD OF THE INVENTION

The present invention relates to a novel system and method for managing the risk for prospective real estate property buyers of an appreciation in the real estate market in which they intend to purchase a property, before they actually purchase a property. Data is input to a computer system and the computer system is used to prepare a Participatory Equity Appreciation Contract or “PEAC” which provides a payment to prospective real estate buyers, determined as a function of the variation in the real estate index of the area in which they intend to purchase a property.

### BACKGROUND OF THE INVENTION

Real estate prices have historically outpaced inflation in the United States. Price trends may be national or regional in nature. National price trends are largely driven by macroeconomic factors, such as the growth of the national gross domestic product, the state of the job market, and the level of mortgage interest rates. Regional price trends are driven by regional variations in supply and demand for real estate. The supply and demand in a particular region is determined by several factors, including the state of the local economy, local demographic trends, the availability of land suited for development, and local zoning laws.

Real estate is one of the largest asset classes in the United States. The purchase of a home is typically the biggest single purchase people make, and is often planned years in advance. Despite the size and importance of real estate transactions, there is no effective manner in which prospective buyers can plan their purchase in advance without incurring the risk of market appreciation between the time the decision to purchase a property in a certain area is made, and the time the property is purchased. Prospective buyers who wish to manage this risk have no other option than to make an immediate investment. However, for many people an immediate investment is impossible, impracticable, or undesirable.

One category of prospective buyers may have an immediate need for the property, and may wish to make an immediate investment, but simply cannot afford to make the down payment required to qualify for a mortgage loan on the property. By the time they may have saved sufficient funds for a down payment, the market may have appreciated beyond their means. At this time, there is no effective way for these people to manage the risk of future price appreciation by using some of their available funds to participate in a potential future real estate market appreciation.

Another category of prospective buyers are able to make the financial outlays required for an immediate purchase but are not willing to incur the practical burden, expense and risk of purchasing, maintaining and operating a property. Property ownership usually involves a significant time commitment to property management activities. Property ownership also entails significant and considerable additional costs and risks, such as real estate brokerage fees, legal fees and taxes, and the risk of extended vacancy affecting potential revenue from the property. At this time, there is no effective way to participate in the real estate market appreciation without incurring any of these expenses and risks. In addition, the financial exposure of direct property ownership extends beyond the amount of equity committed as a down payment to the entire value of the property at the time of purchase, including all loans obtained to finance the purchase. In a market downturn, a situation may materialize where a property owner owes more on a property than it is worth. At this time, prospective property owners have no tool at their disposal that would allow them to limit the amount of loss they are willing to incur, or that would allow them to participate in a real estate market appreciation while limiting their loss from a potential real estate market decline.

For yet another category of prospective buyers, an immediate purchase is undesirable because they have not yet identified a property that they know will meet their future needs, or because they are not certain of what their future needs might be. People in this category know that they will have to make a future real estate purchase, yet are unable to identify a property they would purchase immediately. For example, a young and growing family that is now renting a home may be unable to identify a property for immediate purchase because they have not identified a specific location or property type that is certain to meet their future needs. At this time, there is no effective manner for these people to manage the risk of being priced out of the market in the future. By the time they are ready to make a purchase, the required down payment or monthly mortgage payments on the purchase of the preferred, property may have increased beyond their means.

Generally, real estate market participants have only a limited supply of hedging products at their disposal as compared to other markets. Stock market investors, for example, can buy a multitude of financial products, such as options, to hedge the financial exposure of their stock portfolio. Such financial products may allow a stock market investor to profit from a rise in the price of a certain stock while limiting the potential loss from a price decline. By contrast, real estate investors do not have any similar hedging products at their disposal.

In addition, the methods available to an individual who wishes to invest in real estate are generally limited to three vehicles: direct ownership of property, share ownership in real estate investment companies such as REITs, or syndication. First, direct ownership of property entails the costs and risks of property ownership as described above. Second, share ownership in a real estate investment company involves company-specific risks and, in case of a modest investment, removes any direct decision-making power from the investor. REITs also tend to carry geographically diversified investment portfolios; consequently, their stock prices and dividend payouts will typically show only weak or no correlation with the local real estate market that an investor may be interested in. Finally, syndication involves material participation in a limited liability partnership (LLP) or a limited liability corporation (LLC) dedicated to a specific real estate investment. Typical drawbacks of syndication are the illiquidity of the investment for many years and the dependency of any profit on the performance of a specific property investment project.

All of the three investment vehicles described above have significant limitations and drawbacks. Yet, at the present time, prospective real estate investors have no other practical methods to participate in the gains generated by an appreciating real estate market.

An alternative method to provide indirect ownership of real estate has been proposed by Robert J. Shiller and Allan N. Weiss through their proxy data asset processor (U.S. Pat No. 6,513,020). A proxy asset is a new kind of security that is designed to make effectively tradable existing broad categories of illiquid assets or claims that are individually difficult or impossible to buy, hold, or sell directly. The proxy asset is designed to have a traded market price that reflects the true liquid-market value of the illiquid assets or claims. For example, in the context of real estate, a proxy asset could be designed with an underlying real estate portfolio. This would create a long position for the investor in the real estate market. A proxy asset constitutes a claim on the underlying illiquid asset, group of assets, or cash flows. Unlike our proposed invention, a proxy asset is a security, and shares the characteristics of conventional exchange-traded securities such as liquidity, tradability, uniformity, and the right to assignment.

Proxy assets present several difficulties for prospective homeowners who would wish to use such vehicle for their individual financial planning.

First, a proxy asset-based hedge on the real estate market does not solve the problem of a prospective homebuyer who has insufficient funds for a down payment on the purchase of a property. Such person could not accumulate sufficient funds simply through the ownership of a proxy asset, even in case the market appreciates. For example, in an appreciating market, a $10,000 investment in a proxy asset on an underlying real estate index may appreciate to $15,000 after a number of years. At the same time, a potential target property initially valued at $200,000 may have appreciated to approximately $300,000. Clearly, the $5,000 gain on the proxy asset is not sufficient for the prospective home purchaser to make the down payment on the property that has appreciated in value to $300,000.

Second, proxy assets carry liquidity risk, by relying on active markets with sufficient trading volumes. This risk may materialize when an investor who desires to sell a proxy asset is not able to find a buyer who would purchase it at a fair market price.

Third, proxy assets carry no clear obligation on the part of a counter party to make a payment at a certain time, given a certain outcome. A prospective homeowner planning a home purchase several years in advance will not get iron-clad assurance of a cash payment at the time of home purchase. When owning a proxy asset, the prospective homeowner's ability to realize liquidity required for the purchase of a home will depend upon the proxy asset market's continued existence and vitality.

A number of other initiatives have been launched to create markets in real estate index-based futures that would allow investors to profit from a rise or a fall in the property values without the burden of property ownership or operation. We are aware of three start-up initiatives that offer homeowners the opportunity to purchase futures contracts on a real estate index: the AeFT Exchange in Los Angeles, Calif.; City Index Property Futures in London, England; and IG Index in London, England. A futures contract is a forward contract that is ordinarily traded on an exchange. A forward contract is an agreement to buy or sell an asset at a certain future time for a certain price. These initiatives allow, or are trying to implement a system to allow, customers to buy or sell real estate positions in the future. The present invention can be distinguished from these initiatives of exchange-listed futures in at least three important respects. First, the present invention is not an agreement to buy or sell an asset at a certain future time for a certain price and is therefore not a forward contract. Second, the present invention is not a security and will not be traded on an exchange. Third, the present invention may provide compensation both in case of an increase or a decrease in the index.

Another category of initiatives has been proposed in the context of mortgage loans and is aimed squarely at reducing a homeowner's mortgage payments in exchange for a share in the value appreciation of the mortgaged home. Shared Appreciation Mortgages (SAMs) have been offered since the 1980's. It its original incarnation, a SAM required a one-third share in the value appreciation of a home in exchange for a one-third reduction in the monthly interest payment. Others have proposed alternative mortgage plans where, in the preferred embodiment, the homeowner agrees to pay no interest during the lifetime of the mortgage loan in exchange for a lender's participation in the realized home appreciation (see U.S. Pat. No. 6,345,262 to Madden). While shared appreciation mortgage plans offer to share the upside in the real estate market between the lender and the borrower, they require ownership of the underlying asset by the homeowner, and tie the appreciation sharing arrangement to the mortgage loan. Therefore, we do not consider these initiatives relevant to the present invention.

None of the prior art satisfies the objectives of the present invention, and none shows the basic features of the invention as described below.

### OBJECTS AND SUMMARY OF THE INVENTION

It is an object of the present invention to provide a novel system and method for managing the risk for prospective real estate property buyers of an appreciation in the real estate market in which they intend to purchase a property without the need to make an immediate purchase in such market.

It is another object of the present invention to provide a payout to prospective real estate buyers that is structured as a tiered payment where the size of the various payment tiers and the tiered payment as a whole is determined by the actual deviation of the index of the real estate market in which they intend to purchase a property.

It is yet another object of the present invention to provide prospective real estate buyers with a payout upon purchase of a real estate property which would assist them in funding a down payment on the purchase of the property.

These and other objectives are achieved by the present invention under which data is input into a computer system and the computer system is used to prepare a written contract, referred to as a Participatory Equity Appreciation Contract or a “PEAC,” for a prospective real estate buyer (the “Beneficiary”). Pursuant to the terms of a PEAC, the beneficiary receives a payout (the “participatory payment”), in exchange for a fee, upon purchase of a property. The participatory payment is determined as a function of the change in the level of the real estate index of an area in which the property is located. In the preferred embodiment of the present invention, the beneficiary is only entitled to the participatory payment if the change occurred in the time since the contract was entered into until the earlier of: (i) the end of the term of the contract, or (ii) the time the beneficiary actually purchases a property in the area. Also, in the preferred embodiment, in case the beneficiary is entitled to a participatory payment at the end of the term of the contract but has not yet purchased a property, the beneficiary will only receive the participatory payment at the time of purchase of a property in such area.

In the preferred embodiment of the present invention, the participatory payment has a tiered structure and is composed of one or more tier payments, each corresponding to a tier representing a particular range of index increments. For each tier, the respective tier payment consists of a share of an agreed-upon contract basis where the share is determined as a function of the change of the index, or is a flat pre-determined amount.

In the preferred embodiment, the computer system is used to calculate the participatory payment.

### BRIEF DESCRIPTION OF THE DRAWINGS

The foregoing and other objects of this invention, the various features thereof, as well as the invention itself may be more fully understood from the following description, when read together with the accompanying drawings.

FIG. 1 is a diagram depicting two theoretical models to describe the structure of a PEAC.

FIG. 2 is a diagram depicting the sample Tiered Payment Schedule used for Examples 1, 2 and 3 which outlines the upper and lower boundaries of each Tier and the Tier Payout Rate (r) for each Tier.

FIG. 3 is a diagram depicting the outcome for Example 1.

FIG. 4 is a diagram depicting the outcome for Example 2.

FIG. 5 is a diagram depicting the outcome for Example 3.

### DETAILED DESCRIPTION OF THE INVENTION

Reference will now be made in detail to the preferred embodiments of the invention, examples of which are also provided in the following description. Exemplary embodiments of this invention are described in some detail, although it will be apparent to those skilled in the relevant art that some features which are not particularly relevant to the invention may not be shown for the sake of clarity. Therefore, the examples provided below are primarily given in the context of prospective buyers of residential real estate in a metropolitan area. Nevertheless, it should be obvious that the invention also contemplates applications in the commercial real estate market and in real estate markets other than a metropolitan area such as areas covering a zip code or a particular region or locality.

The present invention relates to a computer system and method for managing the risk of a real estate market appreciation for a prospective real estate property buyer (the “beneficiary”). A set of parameters is input into a computer system and the computer system prepares a Participatory Equity Appreciation Contract or “PEAC.” In the preferred embodiment of the present invention, the set of parameters may consist of up to three subsets. The first subset of parameters includes data relating to the state of the real estate market at the time, such as current and estimated future levels of a real estate market index, local zoning laws and regulations, demographic trends, and current and expected future levels of macroeconomic factors, such as interest rates, growth of gross domestic product, national or regional unemployment rates, or average debt per household. The second subset of parameters includes data reflecting beneficiary-specific factors, such as consumer credit rating or income. The last subset of parameters includes data reflecting certain preferences of the counter-party to the PEAC (the “contract writer”) or reflecting certain preferences of the beneficiary. These parameters include the amount of the contract basis, the level of risk tolerance of the contract writer or the beneficiary, the required expected return to the contract writer or the beneficiary, the preferred schedule of the respective tiers and tier payout rates, the size and structure of the fee payable by the beneficiary, and the term of the PEAC.

On the basis of the input parameters, the computer system will generate the provisions of a proposed PEAC between the beneficiary and the contract writer, which will form the basis for further negotiations and adjustments among and by the beneficiary and the contract writer. In the preferred embodiment of the invention, the proposed terms generated by the computer system include but are not limited to: contract basis, schedule of the respective tiers and tier payout rates, size and structure of fee payable, and term of the contract.

The computer system may also include sophisticated simulation models designed to forecast the values of some or all of the parameters to be input into the computer system and their effect on the provisions of a PEAC. The computer system may also include simulation models designed to generate sets of parameters which, when input into the computer system, would result in the production of a PEAC possessing specific desired characteristics.

A detailed description of the features of the preferred embodiment of a PEAC is provided below.

Term. A PEAC may be a short-term, medium-term or long-term contract. In its preferred embodiment, a PEAC has a fixed term set within a two to six year range.

Index. In the preferred embodiment of the invention, the participatory payment under a PEAC will be determined by the change in the house price index of the metropolitan statistical area (“MSA”) where the beneficiary intends to purchase a property. This index is released quarterly by the Office of Federal Housing Oversight. Utilization of a local or regional index ensures that the participatory payment under a PEAC will be positively correlated with the price appreciation of an average home in the geographic area where the beneficiary intends to purchase a property.

Eligibility for Participatory Payment. In the preferred embodiment of the invention, the deviation of the index that will result in a participatory payment to the beneficiary must be measured at the earlier of: (i) the end of the term of the PEAC, or (ii) the occurrence of a certain life event of the beneficiary. A life event of the beneficiary could be any event that might occur in the beneficiary's life. In the preferred embodiment of the present invention, the relevant life event is defined as the purchase of a property by the beneficiary within the MSA specified in the PEAC.

In case the beneficiary does not purchase a property in the MSA during the term of the PEAC, the beneficiary's participatory payment is calculated based on the index value measured at the end of the term of the PEAC. In the preferred embodiment, while the size of the participatory payment will be determined at the end of the term of the PEAC, the beneficiary will only receive the participatory payment upon occurrence of a life event of the beneficiary; i.e., in the preferred embodiment, when the beneficiary purchases a property in the MSA specified in the PEAC. The beneficiary will not be entitled to receive the participatory payment until such event takes place. An additional time limit may be imposed limiting the eligibility to receive a participatory payment to a fixed period following the end of the term of the PEAC.

In case the beneficiary does purchase a property in the MSA during the term of the PEAC, the beneficiary's participatory payment is calculated based on the index value measured at or about the date of the property purchase. In the preferred embodiment, the participatory payment will also be paid at or about that date.

Index measurement. In the preferred embodiment of the invention, the level of the real estate index is measured at the end of the month, quarter or year in which the PEAC is entered into and at the end of the month, quarter or year in which the life event of the beneficiary occurs or in which the term of the PEAC expires. The PEAC may provide for alternative times at which the index is measured.

Structure of Participatory Payment. In the preferred embodiment of the invention, the participatory payment is structured as a tiered payment consisting of one or more payouts (“Tier Payments”).

The Tier Payments are associated with non-overlapping, discrete index value ranges (“Tiers”). Each Tier is constrained by a lower boundary (tₗ) and an upper boundary (tᵤ). The boundaries quantify possible percentage deviations from the initial index level, which is determined at or about the beginning of the term of the PEAC (the “Initial Index Level”)(I₀). Boundaries above the Initial Index Level (I₀) are expressed as positive values; boundaries below the Initial Index Level (I₀) are expressed as negative values.

For example, one Tier could be defined as the range of index values from a 20% increase through a 30% increase from the Initial Index Level (I₀). Here, (+20%) is the lower boundary of the Tier (tₗ), and (+30%) is the upper boundary of the Tier (tᵤ).

Another Tier could be defined as the range of index values from a 30% increase through a 40% increase from the Initial Index Level (I₀). Here, (+30%) is the lower boundary of the Tier (tₗ), and (+40%) is the upper boundary of the Tier (tᵤ).

Yet another Tier could be defined as the range of index values from a 5% decrease through a 10% decrease from the Initial Index Level (I₀). Here, (−10%) is the lower boundary of the Tier (tₗ), and (−5%) is the upper boundary of the Tier (tᵤ).

Depending on whether the value of the index at the time of calculating the participatory payment (the “Final Index Level”)(Iₜ) falls below, within or above a particular Tier, the beneficiary will be entitled to whole or part of the corresponding Tier Payment for that Tier, or to no Tier Payment at all.
When the Final Index Level (Iₜ) is below or equal to the lower boundary of a Tier (tₗ), the beneficiary is not entitled to the Tier Payment for that Tier.
When the Final Index Level (Iₜ) is above or equal to the upper boundary of a Tier (tᵤ), the beneficiary is entitled to the entire Tier Payment for that Tier.
When the Final Index Level (Iₜ) falls within a particular Tier (i.e., the Final Index Level (Iₜ ) is above the lower boundary of a Tier (tₗ) but below the upper boundary of a Tier (tᵤ), the beneficiary is entitled to a partial Tier Payment, calculated based on the relative distance of the Final Index Level (Iₜ) from the lower boundary of the Tier (tₗ) and the upper boundary of the Tier (tᵤ).

In the preferred embodiment of the invention, a provision may be included in the PEAC specifying that when the Final Index Level (Iₜ) is above or below a certain level, no Tier Payments will be made for some or all Tiers.

Contract Basis. At the time of entering into a PEAC, the contract writer and the beneficiary agree upon a certain monetary amount to be set as the “Contract Basis” (C₀). In the preferred embodiment of the invention, this amount approximates the present value of the property the beneficiary is planning to purchase in the future.

Structure of Tier Payments. A Tier Payment, associated with a particular Tier, is defined as a share of the Contract Basis (C₀). A Tier Payment is determined by: (i) a certain percentage rate agreed upon by the contract writer and beneficiary for the corresponding Tier (the “Tier Payout Rate”)(r), and (ii) the upper and lower boundaries of the corresponding Tier (tᵤ and tₗ), or the Final Index Level (Iₜ) and the lower boundary of the corresponding tier (Iₜand tₗ).
In case the Final Index Level (Iₜ) is above the upper boundary of a Tier (tᵤ), the Tier Payment for that Tier will be equal to the Contract Basis (C₀) times the Tier Payout Rate (r) times the incremental percentage deviation from the Initial Index Level (I₀) associated with that Tier (which can be quantified as the difference between the upper and lower boundaries of the Tier). In a formula, the Tier Payment can be expressed as:

C₀×r×(tᵤ−tₗ)
In case the Final Index Level (Iₜ) is above the lower boundary of a Tier (tₗ) but below the upper boundary of a Tier (tᵤ), there is only a partial Tier Payment for that Tier that will be equal to the product of: (i) the Contract Basis (C₀), (ii) the Tier Payout Rate (r) and (iii) the incremental percentage deviation from the Initial Index Level (I₀) starting at the lower boundary of the Tier (tₗ) and ending at the Final Index Level (Iₜ), which can be quantified as (((Iₜ/I₀)−1)−tₗ). In a formula, the Tier Payment can be expressed as:

C₀r×(((Iₜ/I₀)−1)−tₗ)

Floor Index Level (I_{f}). In the preferred embodiment of the invention, the beneficiary and contract writer will agree upon a level of the index below which the beneficiary will not receive a participatory payment (the “Floor Index Level”)(I_{f}). The Floor Index Level (I_{f}) will coincide with the lower boundary of the bottom Tier. For example, when a Tier covers the range of index values from a 15% decrease through a 20% decrease from the Initial Index Level (I₀) and there are no Tiers below it, the 20% decrease from the Initial Index Level (I₀) is also the Floor Index Level (I_{f}) of that PEAC.

Tiered Payment Schedule. At the time a PEAC is entered into, the beneficiary and contract writer will agree upon a schedule (the “Tiered Payment Schedule”), which will set forth:
The lower and upper boundaries (tₗ and tᵤ) of the respective Tiers;
The Tier Payout Rates (r) for the respective Tiers;
The Initial Index Level (I₀); and
The Floor Index Level (I_{f}).

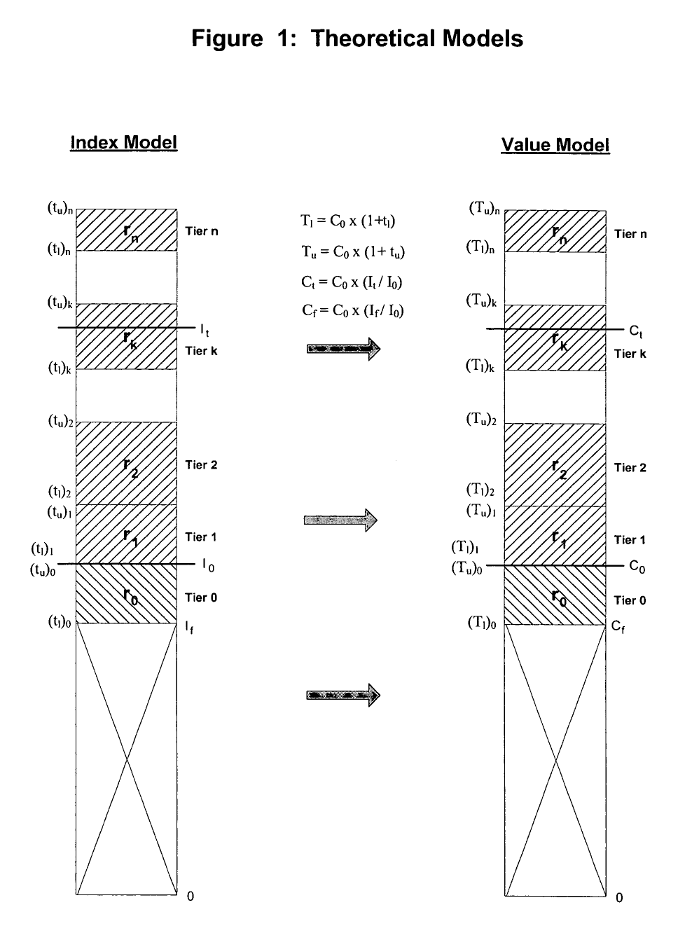

Calculation of Participatory Payment. The structure of the Tiered Payment Schedule and the mechanics of calculating the participatory payment can be expressed as a function of the deviation of the index from the Initial Index Level (I₀) (see FIG. 1—“Index Model”). However, the Index Model does not express the mechanics, structure, or parameters of a PEAC in terms of the actual monetary amount that a specific beneficiary may receive. Therefore, the computer system will be used to translate the Index Model into another model, the “Value Model”, which will express the structure of the Tiered Payment Schedule and the mechanics of calculating the participatory payment in monetary amounts, as a function of the Contract Basis (C₀), agreed upon by the beneficiary and the contract writer. (see FIG. 1—“Value Model”). This, in effect, will make each Value Model beneficiary-specific. The computer system will implement the Value Model generation by automating the following steps:
Set the Initial Index Level (I₀) as the level from which any deviation of the index will be measured.
Express the Floor Index Level (I_{f}) (which is the level of the index below which no participatory payment will be made) as a Contract Floor (C_{f}) (which is a monetary amount determined as a function of the Contract Basis(C₀)). In a formula:

C_{f}=C₀×(I_{f}/I₀)
Express the lower and upper boundaries (tₗ and tᵤ) of each Tier (which, in each case, are percentage deviations from the Initial Index Level (I₀)) as monetary amounts determined as a function of the Contract Basis (C₀). For each Tier, the monetary amount corresponding to the lower boundary of the Tier (tₗ) is called the “lower value boundary” of the Tier (Tₗ) and the monetary amount corresponding to the upper boundary of the Tier (tᵤ) is called the “upper value boundary” of the Tier (Tᵤ). In a formula:

T_{l =}C₀ ×(1+tₗ) and Tᵤ=C₀×(1=tᵤ)
Express the Final Index Level (Iₜ) (which is the level of the index at the time the participatory payment is calculated) as the “Final Contract Level”(Cₜ) (which is a monetary amount determined as a function of the Contract Basis(C₀)). In a formula:

Cₜ=C₀×(Iₜ/I₀)

Using the Value Model, the computer system will calculate the total payout to the beneficiary of a PEAC as follows:

i. For all (Tₗ)ₖ<Cₜ≦(Tᵤ)ₖ, where k≧0, i.e. for all outcomes above Tier 0:

$$V = {\sum }_{i = 0}^{k - 1} {r}_{i} \times ( {( {T}_{u} )}_{i} - {( {T}_{l} )}_{i} ) + {r}_{k} \times ( {C}_{t} - {( {T}_{l} )}_{k} ) ,$$

Where:
V=total payout of the PEAC.
r₀ . . . rₙ=series representing Tier Payout Rates of Tiers 0 through n.
(Tₗ)₀ . . . (Tₗ)ₙ=series representing the lower value boundaries of Tiers 0 through n.
(Tᵤ)₀ . . . (Tᵤ)ₙ=series representing the upper value boundaries of Tiers 0 through n.
Cₜ=Final Contract Level

ii. For all Cₜ≦(Tₗ)₀, i.e. for all outcomes below the contract floor (C_{f}):
V=0

Fee payable. The fee payable by the beneficiary of a PEAC may be due up front, in installments over the term of the PEAC, or at the end of the term of the PEAC. The fee may be a fixed amount, a variable amount determined as a function of the index appreciation or depreciation, or a percentage of the Contract Basis (C₀). In the preferred embodiment of the present invention, the fee is due up front and is structured as a percentage of the Contract Basis (C₀).

In another embodiment of the present invention, the fee may be due at or about the end of the term of the PEAC. In such embodiment, the beneficiary of the PEAC may be required, at the time of purchase of the PEAC, to execute a legally binding document that secures payment of the fee to the contract writer of the PEAC at the end of the term of the PEAC. The document, which may be notarized, may be recorded in public records along with the property records such as the title. Local laws may vary with respect to the contents and restrictions of such a document, notarizing requirements, and recordation requirements and procedures. Consequently, applicable local laws should be considered.

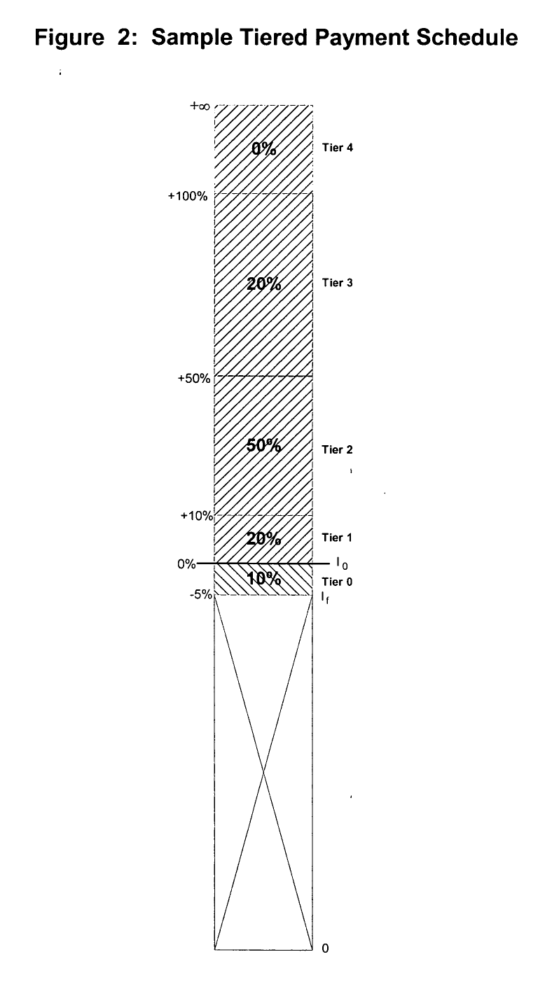

An explanation of a preferred embodiment of the system and method for managing the risk for prospective real estate property buyers in its preferred embodiment will now be provided by way of three specific examples. These examples describe three different outcomes of a PEAC with the Tiered Payment Schedule as illustrated in FIG. 2.

### EXAMPLE 1

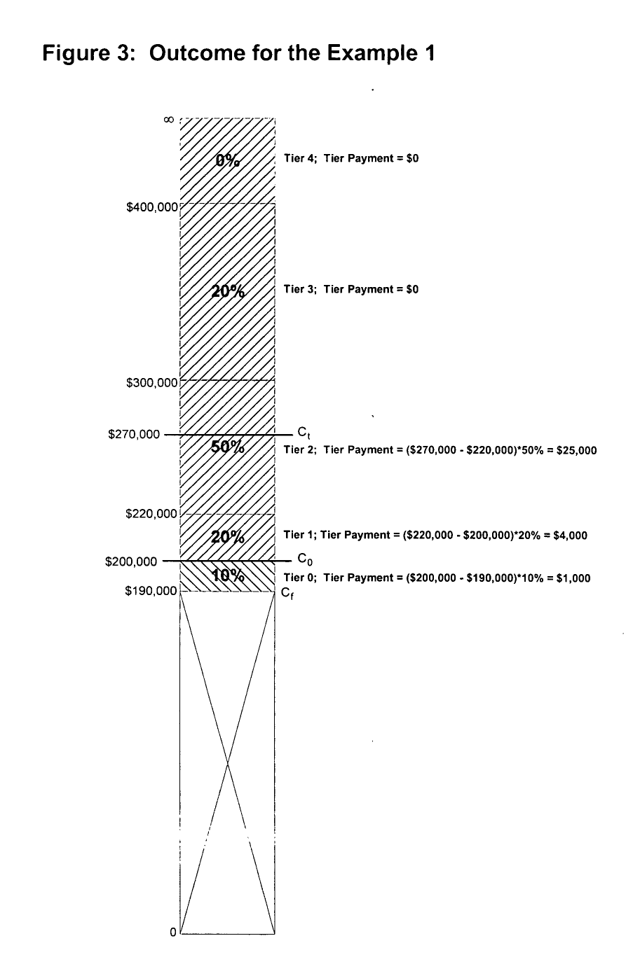

Jerry currently rents his primary residence. However, he anticipates the need to purchase his first home within four years. Jerry projects that a property which is currently worth $200,000 would satisfy his needs. He is concerned about continued price appreciation in the real estate market, and wishes to reduce the risk of being priced out of the market by the time the home is to be purchased. On Feb. 14, 2005, Jerry purchases a PEAC with a term of four years and a Contract Basis (C₀) of $200,000, for a fee of $10,000. On Nov. 29, 2008, Jerry purchases a home for $260,000. At such time, the real estate index has appreciated 35% since the PEAC was purchased, i.e., the Final Index Level (Iₜ) is 35% above the Initial Index Level (I₀). The computer system calculates the participatory payment in terms of the Value Model as illustrated in FIG. 3, as follows:

V=0.10×($200,000−$190,000)+0.20×($220,000−$200,000)+0.50×($270,000−$220,000)
V=$30,000

Jerry is entitled to a participatory payment of $30,000. Although the $10,000 that Jerry had originally paid for the PEAC was not sufficient to make a 10% down payment to purchase his target $200,000 home in 2005, the PEAC participatory payment of $30,000 is now sufficient to make a down payment in 2008 on a home worth $260,000.

### EXAMPLE 2

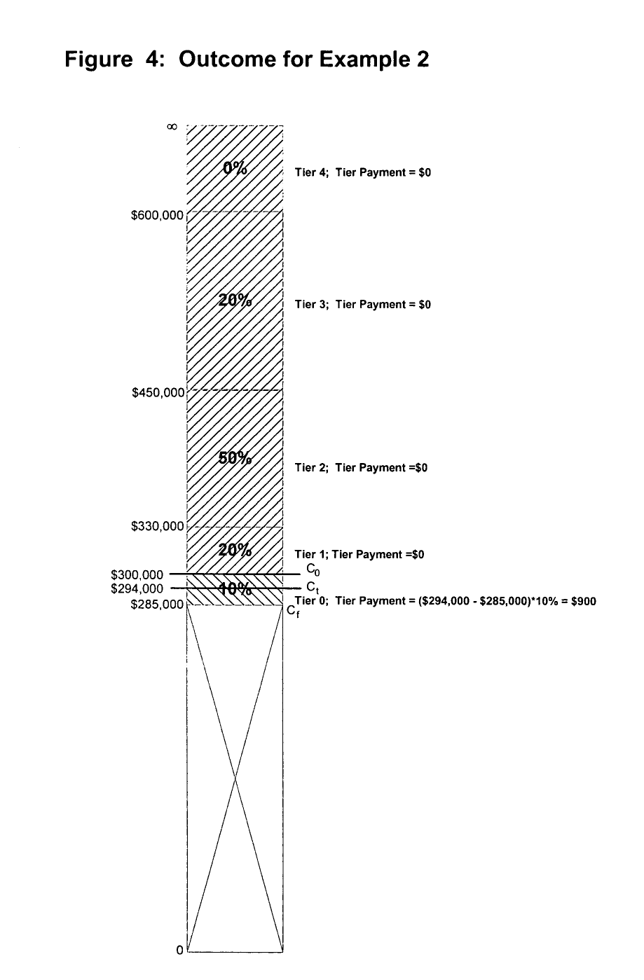

Elaine currently owns a home worth $200,000. However, she anticipates the need to purchase a bigger home within four years. Elaine projects that a property that is currently worth $300,000 would satisfy her expanding family's needs. She is concerned about continued price appreciation in the real estate market, and would like to reduce the risk of being priced out of the market by the time the bigger home is to be purchased. On Feb. 14, 2007, Elaine purchases a PEAC with a term of four years and a Contract Basis (C₀) of $300,000, for a fee of $15,000. On Jul. 16, 2010, Elaine purchases a home for $280,000. At such time, the real estate index has depreciated 2% since the PEAC was purchased, i.e., the Final Index Level (Iₜ) is 2% below the Initial Index Level (I₀). The computer system calculates the participatory payment in terms of the Value Model as illustrated in FIG. 4, as follows:

V=0.10×($294,000−$285,000)=$900

Elaine is entitled to a participatory payment of $900. Although she incurred a loss on the PEAC, Elaine's loss is limited because the PEAC reimbursed her for part of the fee. In addition, Elaine realized savings by purchasing a home for less than she had originally anticipated. Also, during the 3.5 year period that the PEAC was in effect, Elaine enjoyed the psychological benefits of certainty in her family's ability to afford a bigger home.

### EXAMPLE 3

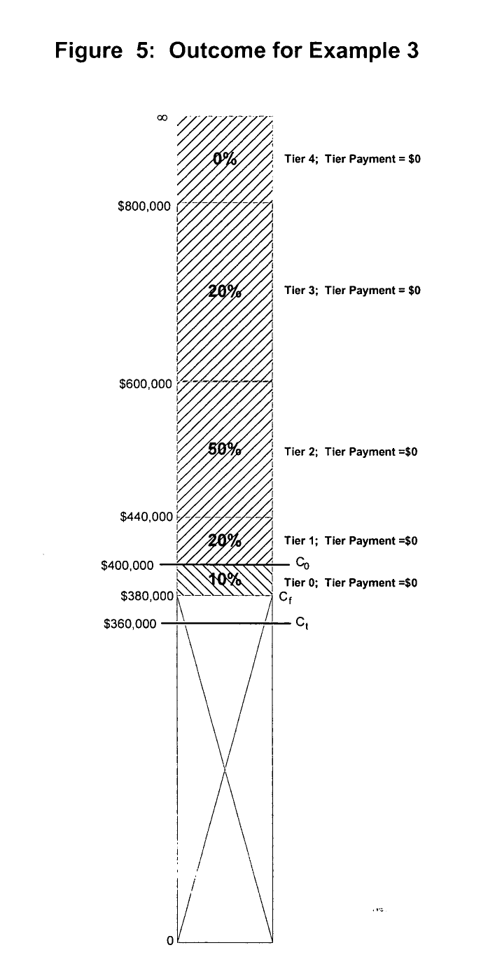

George is an investor with a portfolio of stocks and bonds but no exposure to the real estate market. He has identified several rental units that he thinks might represent an interesting real estate investment opportunity. However, he is concerned about the property-specific risk that he would incur and the immediate burden that the operation of these units may put on his personal schedule. George anticipates that within four years he will have the time to operate the rental units. Meanwhile, he is willing to make an immediate investment in the broad real estate market of the area where he plans to invest in real estate. On Feb. 14, 2008, George purchases a PEAC with a term of four years and a Contract Basis (C₀) of $400,000, for a fee of $20,000. On Oct. 26, 2011, George purchases three rental units for a combined total of $340,000. At such time, the real estate index has depreciated 10% since the PEAC was purchased, i.e., the Final Index Level (Iₜ) is 10% below the Initial Index Level (I₀). The computer system calculates the participatory payment in terms of the Value Model as illustrated in FIG. 5. Because Cₜ is below the Contract Floor (C_{f}) of $380,000, George is not entitled to a participatory payment.

Although George did not recover the fee for the PEAC, he did realize savings by purchasing the units for less than originally anticipated. In addition, George enjoyed the psychological benefits of certainty during the term of the PEAC that he would be able to afford a certain real estate investment in his target area

The features of the computerized process and the terms of a PEAC described above present unique, novel and innovative ways that make the present invention highly attractive for anyone who wants to participate in the appreciation of the real estate market in an MSA without the actual purchase of a property in such MSA.

The written agreement that forms the basis of the PEAC may take a wide variety of forms, within the parameters of applicable law, and the present invention is not limited to any one specific form of agreement, nor is it limited to any particular choice of language.

There are many additional provisions that could be incorporated into a written PEAC contract. Among the provisions that may optionally be included is a provision governing whether the PEAC may be transferable.

The obligation to pay a fee to the contract writer of a PEAC and the future potential payout to the beneficiary may be securitized in the financial markets. Securitization is a method of financing cash flows generated from pooled, structurally similar assets.

In the past 20 years, securitization techniques have become widely applied to a variety of assets, such as residential mortgages, credit card payments, and accounts receivables. An asset is fit for securitization if the cash flows have been engineered to conform to pre-established standards, and if the cash flows from the assets are statistically predictable. The fee payable to the seller of the PEAC and the potential future payout to the beneficiary of a PEAC represent cash flows, which lend themselves well to the asset-backed securitization process.

In addition to the computer system and method where data is input to prepare a PEAC, other methods and procedures can be automated using a combination of custom and off-the-shelf computer software. The software could create customer profiles, process contract exercise claims, track the index at any given point in time during the term of a PEAC and disclose the index level to the beneficiaries of a PEAC, perform Client Relationship Management (CRM) functions, and generate and maintain Standard Operating Procedure (SOP) documentation for the processes relevant to the PEAC administration activities.

In addition, financial calculators based on the PEAC structure and methods may be provided to prospective buyers via the Internet or any other form of distribution for the purpose of self-assessment of the product's applicability to individually-tailored scenarios and situations.

It will be obvious to anyone skilled in the art that the present invention can be employed in a wide variety of embodiments. The preferred and exemplary embodiments of the invention have been described in some detail, but it will be apparent to those skilled in the relevant art that some features which are relevant to the invention may not have been described for the sake of clarity. While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

We claim:

1. A method of using a computer system for preparing a contract which specifies a payout to be made by a contract writer to a beneficiary, calculated as a function of the deviation of a real estate market index, in exchange for a fee.

2. The method of claim 1, wherein the data input into the computer system are parameters relating to the state of the real estate market and parameters relating to the background or preferences of the contract writer or the beneficiary.

3. The method of claim 1, wherein the data input into the computer system are parameters relating to the current and estimated future levels of the real estate market index, local zoning laws and regulations, demographic trends, current and expected future levels of interest rates, growth of gross domestic product, national or regional unemployment rates, and average debt per household; data relating to the beneficiary's consumer credit rating and income; parameters relating to the size, timing and structure of the payout and the fee; the level of risk aversion of the contract writer and the beneficiary; the required expected return to the contract writer and the beneficiary; and parameters relating to the term of the contract.

4. The method of claim 1, wherein the computer system is used to generate proposed provisions of the contract relating to the term of the contract and the size, timing and structure of the payout and the fee.

5. The method of claim 1, further comprising the step of using the computer system to estimate with a high degree of confidence the future levels of any of the parameters that are input into the computer system, and their effect on the terms of the contract.

6. The method of claim 1, further comprising the step of using the computer system to determine the size and characteristics of the input parameters that are required to generate a contract with particular features or provisions.

7. The method of claim 1, further comprising the step of using the computer system to create customer profiles, process contract exercise claims, track the index at any given point in time during the term of the contract and disclose the index level to beneficiaries, perform Client Relationship Management (CRM) functions, and generate and maintain the Standard Operating Procedure (SOP) documentation.

8. The method of claim 1, further comprising the step of using the computer system to provide financial calculators based on the contract structure and methods to prospective buyers via the Internet or any other form of distribution for the purpose of self-assessment of the product's applicability to individually-tailored scenarios and situations.

9. The method of claim 1, wherein the payout is structured in one or more tiers, with a lower and an upper boundary, each such boundary representing a particular proportionate increase or decrease of the index since the beginning of the term of the contract, or about that time, where the entire payout specified for that tier is made in case the index moves above the upper boundary of that tier, and a proportion of the payout specified for that tier is made in case the index moves above the lower boundary of that tier but below the upper boundary of that tier, where such proportion is determined by the proportionate increase of the index above the lower boundary of the tier as compared to the upper boundary of the tier.

10. The method of claim 1, wherein the payout is structured in one or more tiers where the payout for each tier is the product of: (1) an amount agreed upon by the beneficiary and the contract writer at or about the beginning of the term of the contract, (2) a payout rate agreed upon for each tier by the beneficiary and the contract writer at or about the beginning of the term of the contract, and (3) the difference between the lower and upper boundary of the tier each representing a pre-determined proportionate increase of the index since the beginning of the term of the contract or about that time.

11. The method of claim 1, wherein the payout is structured in one or more tiers where the payouts for some or all of the tiers are predetermined fixed amounts, as specified for each tier.

12. The method of claim 1, wherein the payout is structured in one or more tiers where payouts for some or all tiers will not be made if the index level is below or above a certain level at the time of calculating the payout.

13. The method of claim 1, wherein the payout is limited to a certain maximum amount.

14. The method of claim 1, wherein a computer system is used to calculate the potential payout to the beneficiary: (1) at various times during the term of the contract given the level of the index at these times, and (2) at the time the actual payout to the beneficiary is determined.

15. The method of claim 1 wherein the real estate market index is the index representing the average sales price of real estate in a predetermined area where the beneficiary intends to purchase a real estate property.

16. The method of claim 1, wherein the beneficiary's right to receive a payout is contingent upon the occurrence of a life event.

17. The method of claim 16, wherein the life event is the purchase of a real estate property by the beneficiary in the predetermined area.

18. The method of claim 16, wherein the payout is only made when the life event occurs before a point in time agreed upon by the contract writer and the beneficiary.

19. The method of claim 1, wherein the beneficiary is entitled to a payout in case the real estate index exceeds certain pre-determined thresholds, calculated upon the earlier of: (i) the occurrence of a life event, such as the purchase of a real estate property by the beneficiary in the predetermined area, or (ii) the end of the term of the contract.

20. The method of claim 1, wherein the contract has a fixed term.

21. The method of claim 20, wherein the fixed term is in the two to six year range.

22. The method of claim 1, wherein a legally binding document is executed placing an encumbrance on the property owned in whole or in part by the beneficiary, requiring satisfaction of the fee payable to the contract writer.

23. The method of claim 1, wherein the level of the index is measured from the end of the month, quarter or year in which the contract was entered into until the end of the month, quarter or year in which the life event occurred, such as the purchase of a property by the beneficiary, or in which the contract expired.

24. The method of claim 1, wherein the structure and mechanics of the methods and procedures of the contract are automated using computer software deployed on computer workstations, networks, or the Internet.

25. The method of claim 1, wherein the future contingent payout is pooled with other payouts or fee payables and converted into standard securities, backed by those payouts or fee payables, to be issued in the private or public capital markets.

26. The method of claim 1, wherein the fee payable is pooled with other payouts or fee payables and converted into standard securities, backed by those payouts or fee payables, to be issued in the private or public capital markets.
